(19) United States
(12) Patent Application Publication
(10) Pub. No.: US 2013/0264126 A1
(43) Pub. Date: Oct. 10, 2013

(54) Hidden Scale System

(71) Applicant: Eduerdo Osorio, Florence, OR (US)

(72) Inventor: Eduerdo Osorio, Florence, OR (US)

(21) Appl. No.: 13/438,843

(22) Filed: Apr. 4, 2012

(51) Int. Cl. G01G 19/44; G01G 19/52

(52) U.S. Cl. 177/1; 177/132; 177/142

(57) ABSTRACT

In accordance with one or more aspects, a hidden scale system for measuring a person or object is disclosed. The system contains a measuring mechanism that is concealed in the floor of a room or within a piece of furniture. The measuring mechanism transmits the measurement to a display module that displays the measurements to a user. The transmission of the information occurs through a wireless or wired connection.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

The present invention relates to a hidden scale system and, more specifically, to a system containing a hidden measuring mechanism that can be located beneath flooring or concealed in an item; the system being readily available for discrete home or commercial use.

2. Description of the Related Art

Many different types of measuring devices exist in the market today. Scales can measure many attributes of the items placed on them from weight, temperature, density, pressure over an area, to percent body fat and heart rate. The most common use for scales in both home and commercial settings is the measurement of weight. Weight measuring scales are often one unit that contain a mechanical or an electronic device that measures pressure exerted on a plate. A display screen or dial shows the weight in pounds or kilograms.

Traditional scales can be found in bathrooms, kitchens, doctor offices and many other home and commercial locations. Home bathroom scales have many inherent problems such as they are too small to comfortably stand on, are often an eyesore in modern home decor, create a tripping obstacle, are difficult to use for individuals with mobility problems, are inconvenient to store after every use, rust over time due to exposure to water, and are difficult to read because of the location or size of the display. The present invention provides a large, waterproof, hidden weighing mechanism and a separate display that is easy-to-read.

Scales are frequently used in kitchens. Kitchen scales also have inherent problems such as they are awkward to store, take up valuable counter space, and are unattractive and do not match a kitchen's decor. Electronic kitchen scales are often not waterproof making cleanup difficult. Mechanical kitchen scales sometimes have problems with components rusting or breaking due to water exposure or food materials entering the unit. A hidden, waterproof scale installed beneath a countertop would solve many of the aforementioned problems. A commercial kitchen scale with a remote readout, or the capability to transmit information to a smart phone or computer which could allow managers to watch the amount of ingredients used in recipes, would greatly benefit residential and commercial kitchens.

Different types of commercial scales have different types of drawbacks. Truck scales are visibly apparent making surprise weight inspections a near impossibility. A concealed truck weighing system would allow for surprise vehicle weight inspections. Hospital scales are not flush with the floor. Disabled people have difficulty using traditional hospital scales because they have to step onto the scale's weighing surface. Vendor scales are often immovable making it impossible for anyone not within visual range of the scale to receive weight data. Weight data may be required at a register or a computer that is far away from the vendor scale. By way of example, a vegetable department scale or a scale located at a rock quarry is useful only for people that are physically present in those locations.

The present invention provides a hidden scale system that can be concealed beneath a floor, in a piece of furniture, or under a countertop and has an accompanying easy-to-read display system. The present invention solves many of the problems inherent with traditional scale units. It can use any of the existing weighing mechanisms and, by installing it in a concealed manner and incorporating easy to read and remote displays, it successfully updates measuring technology to the ergonomic simplicity and demanded efficiency of the current era.

### BRIEF SUMMARY OF THE INVENTION

Embodiments are disclosed to provide a hidden scale system. The scale system can provide the weight of a user or items placed on the scale. A remote display monitor may be connected to a measuring mechanism that presents the user with measured weight.

In a preferred embodiment of the present invention, a measuring mechanism may be embedded in the floor of a bathroom. The portion of the floor containing the measuring mechanism may be visually indistinguishable from portions of the floor that do not contain the measuring mechanism. Alternatively, only a small seam or separation between the portion of the floor containing the measuring mechanism and the remainder of the floor may be apparent. A wired or wireless display module may be connected to the measuring mechanism but installed in a remote location. The display module may display the user's weight in a clear, easy-to-read digital format.

According to another preferred embodiment of the present invention, the measuring mechanism may be easily accessible for routine maintenance, repairs, calibration, or upgrades. Access to the measuring mechanism may through a removable panel in a piece of furniture, by removing the measuring mechanism from the floor, or by way of an access portal constructed into the floor of a building.

According to another preferred embodiment of the present invention, a measuring mechanism may be embedded into the countertop of a kitchen. Items such as bulk foods, meat, spices, or vegetables could be placed onto the portion of countertop containing the measuring mechanism. A remote display module could display the weight of the items to the user.

In still another preferred embodiment of the present invention, the display module may present the user with information other than the weight of the item being measured. The display module may be network enabled and may receive information from network devices. The information from the network devices could include e-mail messages, text-messages, stock quotes, news headlines, social network information, or any other information capable of being received from a network connection. Additional sensors may be included in the display unit such as thermometers, humidity sensors, barometers, or other environmental measuring devices.

According to another preferred embodiment of the present invention, an integrated scale system may be used in a hospital to measure patients with mobility difficulties. An integrated scale system could be concealed beneath the flooring in a hospital or doctor's office so that patients in wheelchairs or using other mobility assistance devices could be easily measured. A patient in a wheelchair may be placed on the section of flooring containing the hidden scale system and their weight could be displayed on a wall-mounted readout. A patient requiring the use of crutches could walk onto the section of flooring with the hidden scale system and their weight could be displayed on a wall-mounted readout. For hospitals and doctor's offices that provide their own mobility assistance devices, the weight of those devices could be automatically tared from the total measured weight to provide the weight of a patient. The benefit of a concealed scale system in a hospital or doctor's office is the removal of any obstacle or impediment that a patient would have to overcome in order to be measured. The present invention eliminates the need to have a free-standing scale that requires a patient to step onto in order to measure weight. The act of stepping onto a scale is extremely difficult for mobility-challenged individuals and the present invention seeks to reduce their difficulty.

According to another preferred embodiment of the present invention, an integrated scale system may be used in a fitness room or gymnasium to facilitate easier and safer measuring of people engaged in physical fitness activities. In a fitness room or gymnasium, traditional scales take up space and pose a tripping hazard. They are sometimes difficult to see which can result in someone falling over the scale. A gymnasium or fitness room typically contains weight machines, and other fitness equipment that are made from metal or hard plastic. Because of the nature of the equipment, gymnasiums and fitness rooms pose a high risk of injury if someone should stumble or fall. The present invention seeks to reduce that risk by concealing a measurement mechanism beneath the floor of the gymnasium or fitness room in order to free up space and eliminate tripping hazards. Measurements taken by the measurement mechanism can be displayed on an out-of-the way wall-mounted display device. The present invention could be calibrated to support a rubber mat or any flooring section that is usually found in a gymnasium or fitness room.

### BRIEF DESCRIPTION OF THE SEVERAL VIEWS OF THE DRAWING(S)

FIG. 1 is a block diagram of an exemplary method for using a hidden scale system as according to one embodiment of the present invention;

FIG. 2 is a floor plan of an exemplary bathroom containing a hidden scale system as according to one embodiment of the present invention;

FIG. 3 is a simplified schematic diagram for an exemplary measuring mechanism as according to one embodiment of the present invention;

FIG. 4 is a simplified schematic diagram for an exemplary display module as according to one embodiment of the present invention;

FIG. 5 is a view of an exemplary measuring mechanism embedded in a hardwood floor as according to one embodiment of the present invention; and

FIG. 6 is a view of an exemplary hidden scale system with a measuring mechanism embedded in a tile floor and a display module mounted on a wall as according to one embodiment of the present invention.

A further understanding of the present invention can be obtained by reference to a preferred embodiment set forth in the illustrations of the accompanying drawings. Although the illustrated embodiment is merely exemplary of methods for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

In a manner described below, the data processing aspects of the present invention may be implemented, in part, by programs that are executed by a computer. The term “computer” as used herein includes any device that electronically executes one or more programs, such as personal computers (PCs), hand-held devices, multi-processor systems, microprocessor-based programmable consumer electronics, network PCs, minicomputers, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing environments, where tasks are performed by remote processing devices that are linked through a communications network. In a distributed computing environment, programs may be located in both local and remote memory storage devices.

The terms “hidden scale system”, “scale”, and “system” may be used interchangeably herein to refer to the present invention. Although the following description and claims may refer to components of the system in the singular, such as a display module or a measuring mechanism, it is understood that the references may also include components of the system in the multiple.

Several preferred embodiments of the hidden scale system are discussed in this section. However, the invention is not limited to these embodiments. A hidden scale system is any combination of display modules and concealed measuring mechanisms that are used to measure a person or object. The system is not limited in method of measurement, display type, number of displays, or number of measuring mechanisms.

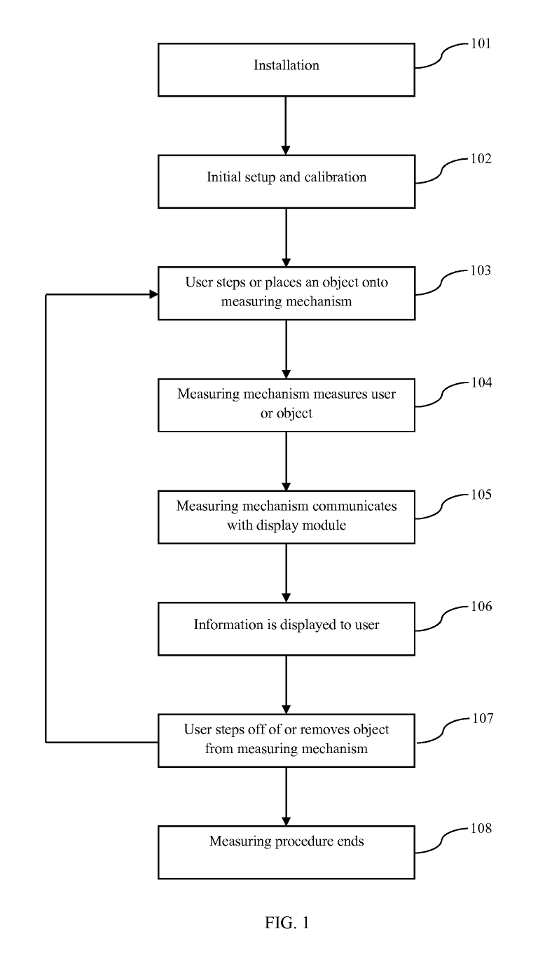

Referring now to FIG. 1, there is shown a block diagram of an exemplary method for using a hidden scale system as according to one embodiment of the present invention. The hidden scale system may be installed (101) into a concealed location in a room. The concealed location may be the floor of a room, such as the floor of a bathroom, or may be in a piece of furniture capable of receiving the scale system. In an exemplary embodiment of the present invention, the measuring mechanism of the hidden scale system may be concealed in a tile floor of a bathroom while the display module may be mounted on a wall near the measuring mechanism. The floor of the bathroom may not appear to have an installed measuring mechanism. The only visible indication of the hidden scale system may be the display module mounted in a conspicuous location. In another embodiment of the present invention, the measuring mechanism may be mounted in a fixture within a room such as within a pedestal or a step capable of receiving the measuring mechanism. The fixture or step, after mounting, may not appear to have the measuring mechanism installed within. The concealment of the measuring mechanism may result in the fixture or step appearing as they did prior to installation of the measuring mechanism. The display module may be placed on a piece of furniture near the measuring mechanism. In yet another embodiment of the present invention, the measuring mechanism may be concealed in a kitchen countertop so that the countertop does not appear to contain a measuring mechanism. The display module may be mounted on a wall in the kitchen.

After installation (101) the hidden scale system may require a setup and calibration procedure (102). The setup and calibration procedure (102) calibrates the system for proper measurement display. Calibration (102) may also include a taring step that deducts the weight of any materials installed on the measuring mechanism. These materials may be parts of a floor or countertop that have been affixed to the measuring mechanism in order to conceal its existence. By way of example, a section of carpet may be affixed to the measuring mechanism if the scale system is installed in a room with carpeted floors.

After the initial setup and calibration step (102), the scale system may be used by a user. The user begins use of the system by stepping or placing an object onto the measuring mechanism (103). The weight of the person or the object on the sensor is measured. Other characteristics about the user or the object may be measured as well. The measuring mechanism may include a sensor for measuring the body mass index (BMI) or the person, or the density of an object. The measuring mechanism may also perform a bioelectrical impedance analysis (BIA) of the person to estimate their body fat. It is possible that the measuring mechanism may also measure the temperature of the person or object being measured.

Once the measurements have been taken (104), the measuring mechanism may communicate the results to the display module (105). Communication may occur through a wired connection, or may occur through a wireless connection such as Bluetooth, infrared, WiFi, or any other appropriate wireless connection means. The display module receives the measurements from the measuring mechanism then may display the measurements to the user (106). Some or all of the measured information may be displayed (106), depending on the user's configuration of the display module. The user may decide that he or she wishes to see only the weight of the person or object being measured (104), or may wish to see only the temperature of the person or object being measured (104). The user may even configure the display module to display combinations of information (106) such as the weight and BMI, or the temperature and density of the person or object being measured (104).

The user could then step off of or remove the object from the measuring mechanism (107). The measured information may still appear on the display module after the measuring mechanism is no longer in use. This provides the benefit of allowing the user to see the information without having to remain stationary or without having to leave the object on the measuring mechanism for an extended period of time. Once the user has stepped off of or removed the object from the measuring mechanism (107), the user may step back onto or place the same or another object back on to the measuring mechanism (103) to begin a new measuring session. The repeated process of measurement, steps (103) to (107), may be repeated for as many times as the user wishes. Once the user decides measurements are no longer necessary, the measuring procedure ends (108).

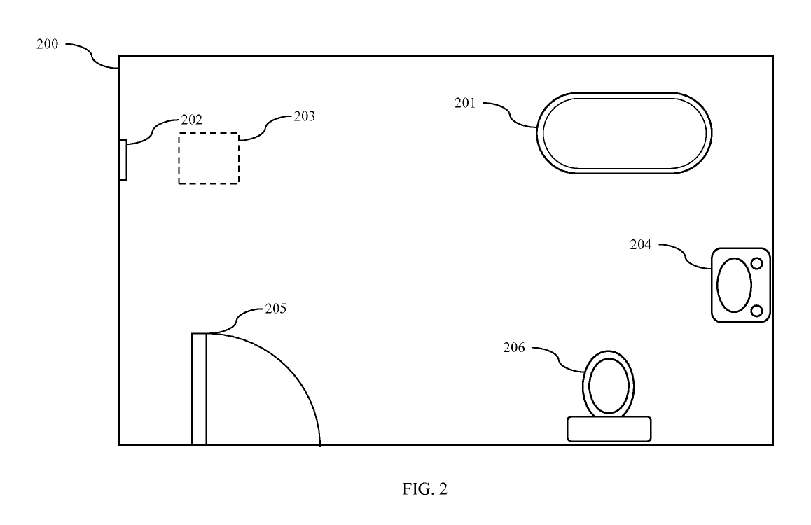

Referring now to FIG. 2, there is shown a floor plan of an exemplary bathroom containing a hidden scale system as according to one embodiment of the present invention. The bathroom (200) may contain common fixtures including a bathtub (201), a sink (204), and a toilet (206). The bathroom (200) may be accessed by a door (205) that leads to other rooms or to the outdoors. The hidden scale system may be located in a corner of the bathroom (200) so that its use does not interfere with any of the other fixtures. The measuring mechanism (203) may be concealed under the flooring so that the portion of the floor where the measuring mechanism (203) is located could be visually indistinguishable from the rest of the floor. The measuring mechanism (203) may be waterproof so a user that is wet will not damage the measuring mechanism (203). The display module (202) may be affixed to the wall near the measuring mechanism (202) so that someone standing on the measuring mechanism (203) could easily see the displayed information. The display module (202) may be a digital display for easy viewing. The display module (202) may also be waterproof. The hidden scale system may be operable by voice command for users with disabilities. The system may also have a remote control to facilitate use even if the user is not in direct contact with the system.

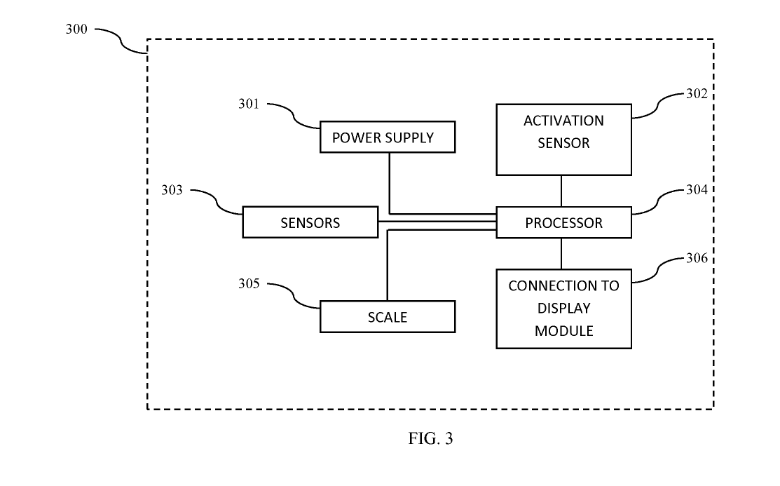

Referring now to FIG. 3, there is shown a simplified schematic diagram for an exemplary measuring mechanism (300) as according to one embodiment of the present invention. The measuring mechanism (300) may be the component of the hidden scale system that performs measurements such as determining the weight, BMI, or temperature of a person or object. The measuring mechanism may contain a power supply (301) that could be a battery or a connection to a building's electrical wiring. The power supply may be connected to a processor (304) within the measuring mechanism. The processor (304) could be responsible for data processing, information flow, and for satisfying the computational requirements of the measuring mechanism (300). The measuring module (300) may contain an activation sensor (302) that senses the presence of a person or object on the measuring module (300). The presence of a person or object could be sensed by detecting pressure exerted on the measuring module (300) by that person or object. The activation sensor (302) could be connected to the processor (304) that may begin measuring procedures after receiving a signal from the activation sensor (302). A connection to the display module (306) may be used to transmit or receive information. The connection (306) could be a wired connection, or could be a wireless connection. The wireless connection technology used as the connection to the display module (306) may include Bluetooth, WiFi, radio frequency, infrared, or any other wireless connection technology deemed appropriate to communicated information from the measuring mechanism (300) to the display module. The connection to the display module (306) may be controlled by the processor (304). The measuring mechanism (300) may contain a scale (305) for measuring the weight of a person or object. The measurements taken from the scale may be transmitted to the processor (304) then on to the display module via the connection to the display module (306). The measuring mechanism (300) may also contain additional sensors (303) that measure such characteristics as temperature of the person or object being measured, the BMI of the person being measured, or may perform a BIA analysis of the person being measured. The sensors (303) may also measure the density of an object placed on the measuring mechanism (300). The information gathered by the additional sensors (303) could be communicated to the display module through the connection to the display module (306).

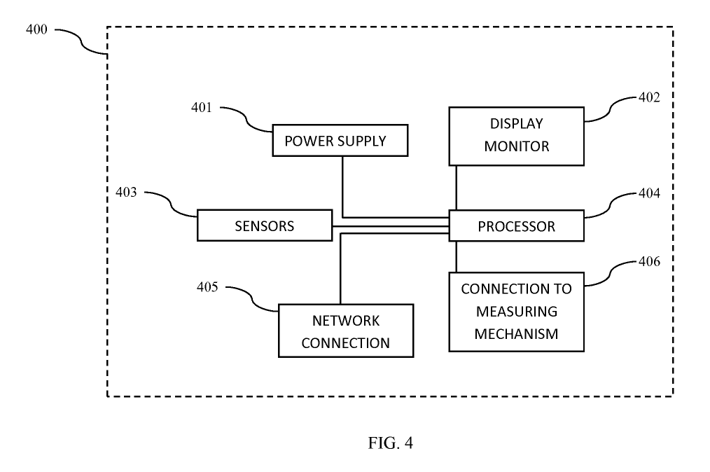

Referring now to FIG. 4, there is shown a simplified schematic diagram for an exemplary display module (400) as according to one embodiment of the present invention. The display module (400) may be the component of the hidden scale system that displays measured information to the user. The display module (400) may contain a power supply (401) that is a battery or a connection to a building's electrical wiring. The display module (400) may contain a display monitor (402) that displays information to a user. The display monitor (402) could be an liquid crystal display (LCD), a light-emitting diode (LED) display, an electronic paper or E-ink display, an organic light-emitting diode display, a plasma display, a thin-film transistor (TFT) display, or any other type of display suitable for displaying information to the user. The display module (400) may contain additional sensors (403) that measure ambient conditions. These additional sensors (403) could include barometers, hygrometers, thermometers, or any other type of sensor included with the hidden scale system. The display module (400) may contain a processor (404) that could be responsible for data processing, information flow, and for satisfying the computational requirements of the display module (400). The display module (400) may contain a connection to the measuring mechanism (406) that is used to communicate data to or from the measuring mechanism (300). Data received from the measuring mechanism (300) could include measurements or system commands. Data sent to the measuring mechanism (300) could include requests or system commands. The display module (400) could have a network connection (405) that may be used to communicate with other computing devices or networks. The network connection (405) may be used to send or receive data to or from the hidden scale system. Data sent from the scale system through the network connection (405) could include measurements such as a person's weight or BMI, while data received by the scale system through the network connection (405) could include stock prices, news headlines, weather information, or system commands from remote monitoring devices. The display module (400) may also present the measurements to the user through voice output.

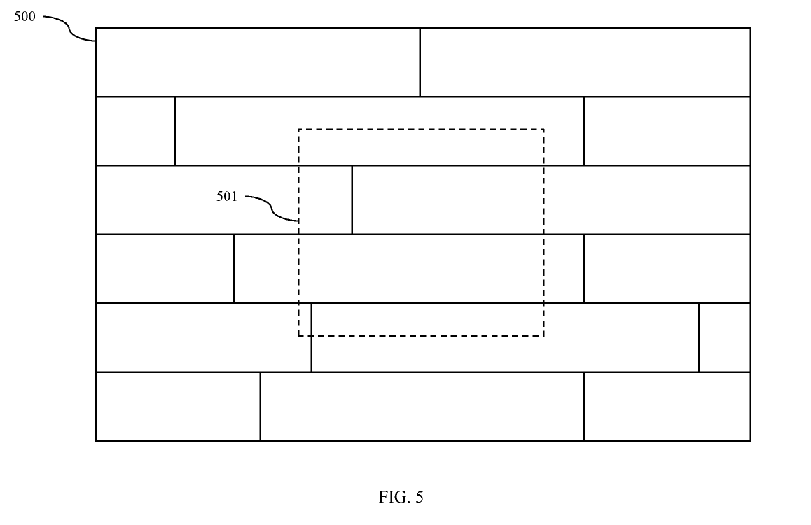

Referring now to FIG. 5, there is shown a view of an exemplary measuring mechanism (501) embedded in a hardwood floor (500) as according to one embodiment of the present invention. The wood planks of the hardwood floor (500) may form a continuous surface over the embedded measuring mechanism (501) that has been concealed beneath the floor (500). The visual appearance of the hardwood floor (500) may be that of an unbroken, seamless floor with no obvious signs that the measuring mechanism (501) has been installed underneath the floor's (500) surface. Wood planks may be cut and placed on the measuring mechanism (501) in order to conceal it from view. The cuts in the flooring (500) may be done in such as a way that the separations are not visible to a user using the hidden scale system.

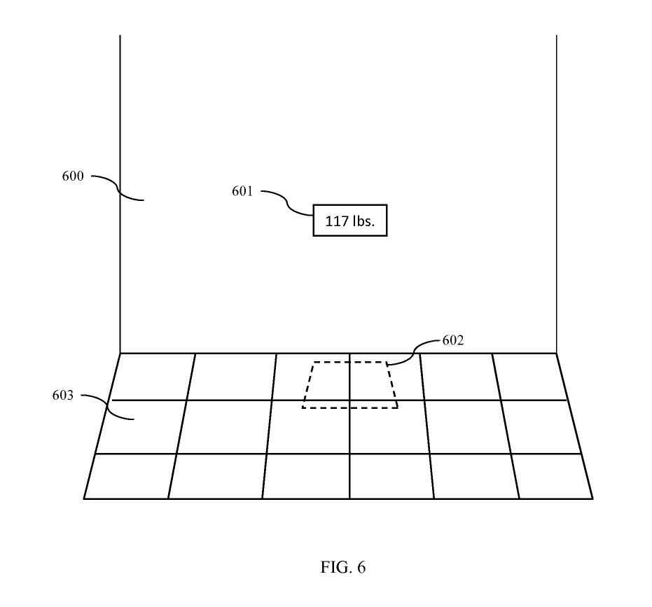

Referring now to FIG. 6, there is shown an exemplary hidden scale system with a measuring mechanism (602) embedded in a tile floor (603) and a display module (601) mounted on a wall (600) as according to one embodiment of the present invention. The tiles in the tile floor (603) may form a continuous surface over the embedded measuring mechanism (602) that has been concealed beneath the floor (603). The visual appearance of the tile floor (603) may be that of an unbroken, seamless floor with no obvious signs that the measuring mechanism (602) has been installed underneath the floor's (603) surface. Tiles may be cut and placed on the measuring mechanism (602) in order to conceal it from view. The cuts in the tile floor (603) may be done in such a way that the separation between the portion of the floor (603) that does not contain the measuring mechanism (602) and the portion of the floor (603) that does contain the measuring mechanism (602) is indistinguishable to a user. The display module (601) could be mounted on a wall (601) near the embedded measuring mechanism (602) so that displayed information is easily viewed by the user.

It should be noted that the example software and/or firmware implementations described herein may be optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A hidden scale system comprising:
a measuring mechanism configured to measure a person or an object, the measuring mechanism being located in a place of concealment;
a display module associated with the measuring mechanism, the display module configured to display information received from the measuring mechanism or from an external device; and
a connection for transmitting information between the measuring mechanism and the display module.

2. The hidden scale system of claim 1, wherein the measuring mechanism is configured to measure the weight of the person or object.

3. The hidden scale system of claim 1, wherein the place of concealment is underneath a floor.

4. The hidden scale system of claim 1, wherein the display module is configured to be mounted on a wall.

5. The hidden scale system of claim 1, wherein the display module is configured to be freestanding.

6. The hidden scale system of claim 1, wherein the hidden scale system is activated by voice or a remote control.

7. The hidden scale system of claim 1, wherein the connection is a wireless connection.

8. A method for measuring comprising:
concealing a measuring mechanism in a location that is not visible to a user;
obtaining a measurement from an individual or an object when the individual or object is placed on the measuring mechanism;
transmitting the measurement from the measuring mechanism to a display module; and
displaying the measurement on the display module.

9. The method of claim 8, wherein the location is underneath a floor.

10. The method of claim 8, wherein the measuring mechanism is configured to measure the weight of the person or object.

11. The method of claim 8, wherein the display module is configured to be mounted on a wall.

12. The method of claim 8, wherein the display module is configured to be freestanding.

13. The method of claim 8, wherein the measurement is transmitted from the measuring mechanism to the display module over a wired connection.

14. The method of claim 8, wherein the measurement is transmitted from the measuring mechanism to the display module over a wireless connection.

15. A scale comprising:
one or more sensors contained within a concealed measuring mechanism that are configured to obtain one or more measurements from a person or object;
a transmission means configured to transmit information from the one or more sensors over a wired or wireless connection; and
a display module configured to receive information from the transmission means and configured to display the information to a user.

16. The scale of claim 15, wherein the concealed measuring mechanism is located within a floor.

17. The scale of claim 15, wherein at least one of the measurements is the weight of the person or object.

18. The scale of claim 15, wherein the display module is configured to be mounted on a wall.

19. The scale of claim 15, wherein the scale may be activated by voice or a remote control.

20. The scale of claim 15, wherein the display module is further configured to receive information from an external device.
